(19) United States
(12) Patent Application Publication
(10) Pub. No.: US 2025/0087693 A1
(43) Pub. Date: Mar. 13, 2025

(54) CATHODE ELECTRODE SHEET, A PREPARATION METHOD THEREOF AND A LITHIUM-ION BATTERY COMPRISING SAME

(71) Applicant: MURATA MANUFACTURING CO., LTD., Kyoto (JP)

(72) Inventors: Yuxing LIAO, Shanghai (CN); Yuli LI, Shanghai (CN); Kazumasa TAKESHI, Shanghai (CN)

(21) Appl. No.: 18/795,449

(22) Filed: Aug. 6, 2024

(30) Foreign Application Priority Data
Sep. 8, 2023 (CN) 2023111617432

(51) Int. Cl. H01M 4/62; H01M 4/02; H01M 4/04; H01M 4/58; H01M 4/66; H01M 4/75; H01M 10/0525

(52) U.S. Cl. CPC H01M 4/624; H01M 4/0404; H01M 4/5825; H01M 4/661; H01M 4/75; H01M 10/0525; H01M 2004/021; H01M 2004/028

(57) ABSTRACT

A cathode electrode sheet, a preparation method thereof, and a lithium-ion battery are provided. The cathode electrode sheet comprises a cathode active material, a cathode conductive agent, a cathode binder, and a lithium organic acid, wherein based on the total weight of the cathode active material, the cathode conductive agent, the cathode binder, and the lithium organic acid, the content of the lithium organic acid is 0.14 wt % to 11.99 wt %.

### CROSS REFERENCE TO RELATED APPLICATIONS

The present application claims priority to Chinese patent application no. 2023111617432, filed on Sep. 8, 2023, the entire contents of which are incorporated herein by reference.

### BACKGROUND

The present disclosure relates to the field of battery electrode materials, specifically to a cathode electrode sheet, a preparation method thereof, and a lithium-ion battery comprising same.

In order to improve the high-current charge and discharge performance of lithium-ion batteries so as to meet the requirements of high-power characteristics for hybrid electric vehicles, etc., one approach is to use nanometerization or micrometerization of the cathode and anode electrode materials. On the one hand, it can shorten the migration distance of lithium ions in the electrode material particles, and on the other hand, it can increase the specific surface area of the electrode materials, resulting in multi-pathway of intercalation and deintercalation of lithium ions in the electrode materials, thereby improving the high-current charge and discharge capacity of electrodes.

However, a new problem arises after the nanometerization or micrometerization of electrode materials, that is, due to the small particle size and high specific surface energy of nano-sized or micron-sized materials, they are prone to agglomeration and not easy to disperse, resulting in existence of particles on the electrode surface and settlement of slurry during the preparation of electrodes easily, moreover the electrode materials are prone to detachment from the current collector, which seriously affects the cycle life of the battery.

A method for dispersion micron-sized or nano-sized electrode materials has been proposed in the prior art, which can make the dispersion of the micron-sized or nano-sized materials more uniform and stable by adding an organic acid that is decomposed at 150° C. to the slurry. This method can prevent the settlement of slurry, while the organic acid is decomposed into carbon dioxide and water at 150° C., which will volatilize, thereby improving the capacity, initial efficiency, and cycle life of the battery; at the same time, it can improve the adhesion between the coated electrode and the current collector, thereby improving the cycle life of the battery.

However, these methods in the prior art have not studied on the neutralization of an organic acid on the residual alkali in the electrode materials, the effect on pore formation and inter-structure of particles in the thick-coated electrodes, and therefore does not involve in the research of reducing the tortuosity of the electrode and improving the rate performance of the materials.

Moreover, although the thick-coated electrodes with an electrode material can increase the energy density of the battery, they have poor conductivity and rate performance.

### SUMMARY

The present disclosure relates to the field of battery electrode materials. More specifically, for example, the present disclosure relates to a cathode electrode sheet, a preparation method thereof, and a lithium-ion battery comprising same. The present disclosure relates to providing, in an embodiment, a cathode electrode sheet, a preparation method thereof, and a lithium-ion battery comprising same, so as to solve the technical problem that the processability, conductivity, and rate performance is poor.

According to an embodiment of the present disclosure, a cathode electrode sheet is provided, comprising a cathode active material, a cathode conductive agent, a cathode binder, and a lithium organic acid, wherein based on the total weight of the cathode active material, the cathode conductive agent, the cathode binder, and the lithium organic acid, the content of the lithium organic acid is 0.14 wt % to 11.99 wt %.

Further, in an embodiment, micropores of 1 microns to 10 microns are comprised inside the cathode electrode sheet, and the lithium organic acid is enriched around the micropores.

Further, in an embodiment, the lithium organic acid is distributed on the surface of the cathode active material and the cathode conductive agent.

Further, in an embodiment, the organic acid radical in the lithium organic acid is derived from one or more of maleic acid, glycolic acid, acrylic acid, fumaric acid, malonic acid, succinic acid, malic acid, tricarballylic acid, and aconitic acid.

Further, in an embodiment, the cathode active material is selected from one or more of lithium manganate, lithium cobaltate, lithium iron phosphate, lithium titanate, and lithium iron manganese phosphate.

Further, in an embodiment, the lithium organic acid is lithium maleate, and the content of the lithium maleate is 0.23 wt % to 8.83 wt %.

According to another embodiment of the present disclosure, a method for preparing a cathode electrode sheet is provided, comprising the following steps:—step S1: mixing the cathode active material, the cathode conductive agent, the cathode binder, and lithium carbonate to obtain a first slurry; and—step S2: adding an organic acid to the first slurry and mixing them to obtain a second slurry, then preparing the second slurry into a cathode electrode sheet, or preparing the first slurry into a primary electrode sheet, and then applying an organic acid onto the primary electrode sheet to produce the cathode electrode sheet.

Further, in an embodiment, the method further comprises the step S3 of drying the cathode electrode sheet obtained in the step S2 to produce a cathode electrode sheet with micropores, preferably the drying temperature in the step S3 is 100-150° C.

Further, in an embodiment, the addition ratio of lithium carbonate is 0.05 wt % to 5 wt % of the solid component in the first slurry.

Further, in an embodiment, the organic acid is selected from one or more of maleic acid, glycolic acid, acrylic acid, fumaric acid, malonic acid, succinic acid, malic acid, tricarballylic acid, and aconitic acid.

Further, in an embodiment, the cathode active material is selected from one or more of lithium manganate, lithium cobaltate, lithium iron phosphate, lithium titanate, and lithium iron manganese phosphate.

Further, in an embodiment, the particle size of lithium carbonate is 50 nm to 10 μm.

Further, in an embodiment, the step S1 comprises the following steps:—step S11: mixing the cathode conductive agent, cathode binder, and the solvent to obtain a uniform solution;—step S12: adding lithium carbonate to the uniform solution to obtain a conductive binder solution; and—step S13: adding the cathode active material to the conductive binder solution to obtain the first slurry.

Further, in an embodiment, the step S2 comprises the following steps:—step S21: adding an organic acid to the first slurry and mixing them to obtain a second slurry, then evenly coating the second slurry onto the aluminum foil to prepare the cathode electrode sheet; or—step S22: evenly coating the first slurry onto the aluminum foil to prepare a primary electrode sheet, then spray coating an organic acid ethanol solution onto the primary electrode sheet or soaking the primary electrode sheet in an organic acid ethanol solution to prepare the cathode electrode sheet.

Further, in an embodiment, the step S2 further comprises a step S23: cleaning the cathode electrode sheet with an ethanol solution after the step S22.

According to yet another embodiment of the present disclosure, a lithium-ion battery is provided, comprising a cathode electrode sheet, a anode electrode sheet, and a separator, wherein the cathode electrode sheet is the cathode electrode sheet described above in the present disclosure or prepared by the method of the present disclosure.

In the cathode electrode sheet, the preparation method thereof, and the lithium-ion battery comprising same of the present disclosure, in an embodiment, by adding lithium carbonate to the slurry and adding an organic acid to the slurry or soaking the electrode sheet in an organic acid, CO₂ and H₂O are generated during the neutralization reaction, resulting in the formation of micropore structures and more direct lithium-ion channels in the electrode sheet during the drying process, which can reduce the tortuosity and McMullin number (Nm) of the electrode sheet under the same volume density, and improve the electrochemical performance of a battery such as conductivity and rate performance. Meanwhile, the addition of an organic acid can effectively reduce the residual alkali content in the cathode active material and improve the processability of the slurry.

### BRIEF DESCRIPTION OF THE FIGURES

FIG. 1 shows a schematic diagram of a cathode electrode sheet made with or without the addition of lithium carbonate and an organic acid additive.

FIG. 2 shows a schematic diagram showing the formation of micropore structures in the electrode sheet by CO₂ and H₂O generated by the reaction of lithium carbonate and an organic acid, as well as the enrichment of lithium organic acid around the micropores.

FIG. 3 shows the fitting curve obtained based on the fitting method in Reference [Journal of The Electrochemical Society, 163 (7) A1373-A1387 (2016)].

### DETAILED DESCRIPTION

It is to be noted that embodiments in the present disclosure and features in the embodiments can be combined in any suitable manner according to an embodiment. Hereinafter, the present disclosure is described in further detail according to one or more embodiments.

As stated in the Background section, methods for dispersing the micron-sized or nano-sized materials by an organic acid have been proposed. However, although these methods can increase the energy density of a battery, such methods have poor conductivity and rate performance, and these methods have not studied on the neutralization of an organic acid on the residual alkali in the electrode materials. Therefore, there is still a need for further improvement. In view of such problems, according to an embodiment of the present disclosure, a cathode electrode sheet is provided, comprising a cathode active material, a cathode conductive agent, a cathode binder, and a lithium organic acid, wherein based on the total weight of the cathode active material, the cathode conductive agent, the cathode binder, and the lithium organic acid, the content of the lithium organic acid is 0.14 wt % to 11.99 wt %.

Preferably, in an embodiment, micropores of 1-10 microns are comprised inside the cathode electrode sheet, and the lithium organic acid is enriched around the micropores.

Preferably, in an embodiment, the lithium organic acid is distributed on the surface of the cathode active material and the cathode conductive agent.

In an embodiment of the present disclosure, by adding lithium carbonate to the slurry and adding an organic acid to the slurry or soaking the electrode sheet in an organic acid, CO₂ and H₂O are generated during the neutralization reaction, resulting in the formation of micropore structures and more direct lithium-ion channels in the electrode sheet during the drying process, which can reduce the tortuosity and McMullin number of the electrode sheet under the same volume density, and improve the electrical performance of a battery such as conductivity and rate performance.

Meanwhile, the addition of an organic acid can effectively reduce the residual alkali content in the cathode active material and improve the processability of the slurry.

Preferably, in an embodiment, the content of lithium organic acid can be 0.14 wt %, 0.2 wt %, 0.5 wt %, 0.8 wt %, 1.0 wt %, 1.2 wt %, 1.5 wt %, 1.8 wt %, 2.0 wt %, 2.2 wt %, 2.5 wt %, 2.8 wt %, 3.0 wt %, 3.2 wt %, 3.5 wt %, 3.8 wt %, 4.0 wt %, 4.2 wt %, 4.5 wt %, 4.8 wt %, 5.0 wt %, 5.2 wt %, 5.5 wt %, 5.8 wt %, 6.0 wt %, 6.2 wt %, 6.5 wt %, 6.8 wt %, 7.0 wt %, 7.2 wt %, 7.5 wt %, 7.8 wt %, 8.0 wt %, 8.2 wt %, 8.5 wt %, 8.8 wt %, 9.0 wt %, 9.2 wt %, 9.5 wt %, 9.8 wt %, 10.0 wt %, 10.2 wt %, 10.5 wt %, 10.8 wt %, 11.0 wt %, 11.2 wt %, 11.5 wt %, 11.8 wt % or 11.99 wt %.

Preferably, in an embodiment, the size of the micropores inside the cathode electrode sheet can be 1 micron, 1.1 microns, 1.2 microns, 1.3 microns, 1.4 microns, 1.5 microns, 1.6 microns, 1.7 microns, 1.8 microns, 1.9 microns, 2 microns, 2.1 microns, 2.2 microns, 2.3 microns, 2.4 microns, 2.5 microns, 2.6 microns, 2.7 microns, 2.8 microns, 2.9 microns, 3 microns, 3.1 microns, 3.2 microns, 3.3 microns, 3.4 microns, 3.5 microns, 3.6 microns, 3.7 microns, 3.8 microns, 3.9 microns, 4 microns, 4.1 microns, 4.2 microns, 4.3 microns, 4.4 microns, 4.5 microns, 4.6 microns, 4.7 microns, 4.8 microns, 4.9 microns, 5 microns, 5.1 microns, 5.2 microns, 5.3 microns, 5.4 microns, 5.5 microns, 5.6 microns, 5.7 microns, 5.8 microns, 5.9 microns, 6 microns, 6.1 microns, 6.2 microns, 6.3 microns, 6.4 microns, 6.5 microns, 6.6 microns, 6.7 microns, 6.8 microns, 6.9 microns, 7 microns, 7.1 microns, 7.2 microns, 7.3 microns, 7.4 microns, 7.5 microns, 7.6 microns, 7.7 microns, 7.8 microns, 7.9 microns, 8 microns, 8.1 microns, 8.2 microns, 8.3 microns, 8.4 microns, 8.5 microns, 8.6 microns, 8.7 microns, 8.8 microns, 8.9 microns, 9 microns, 9.1 microns, 9.2 microns, 9.3 microns, 9.4 microns, 9.5 microns, 9.6 microns, 9.7 microns, 9.8 microns, 9.9 microns or 10 microns.

In a further embodiment of the present disclosure, the organic acid radical in the lithium organic acid is derived from one or more of maleic acid, glycolic acid, acrylic acid, fumaric acid, malonic acid, succinic acid, malic acid, tricarballylic acid, and aconitic acid. The organic acids from the above list are easier to be obtained commercially and more cost-effective, and by using the organic acids from the above list, CO₂ and H₂O can be better generated during the neutralization reaction, resulting in the formation of more micropore structures and more direct lithium-ion channels in the cathode electrode sheet during the drying process.

In a further embodiment of the present disclosure, the cathode active material is selected from one or more of lithium manganate, lithium cobaltate, lithium iron phosphate, lithium titanate, and lithium iron manganese phosphate. The above are just examples of the cathode active materials, which are not limited thereto. Those skilled in the art can choose appropriate cathode active materials according to actual needs.

In a further embodiment of the present disclosure, the lithium organic acid is lithium maleate, and the content of lithium maleate is 0.23 wt % to 8.83 wt %. Compared to other acids, maleic acid is easier to be obtained commercially and more cost-effective. By selecting lithium maleate with the above content, sufficient micropore structures and direct lithium-ion channels can be generated in the cathode electrode sheet without wasting, thus saving costs.

According to another embodiment of the present disclosure, a method for preparing a cathode electrode sheet is provided. The method comprises the following steps:—step S1: mixing the cathode active material, the cathode conductive agent, the cathode binder, and lithium carbonate to obtain a first slurry; and—step S2: adding an organic acid to the first slurry and mixing them to obtain a second slurry, then preparing the second slurry into a cathode electrode sheet, or preparing the first slurry into a primary electrode sheet, and then applying an organic acid onto the primary electrode sheet to produce the cathode electrode sheet.

In the method for preparing the cathode electrode sheet in the present disclosure, in an embodiment, by mixing lithium carbonate with the cathode active material, the cathode conductive agent, and the cathode binder, the lithium carbonate can occupy a position in the first slurry, and then by adding an organic acid to the first slurry or applying an organic acid onto the primary electrode sheet, the organic acid is made to react with lithium carbonate to generate CO₂ and H₂O, resulting in the formation of more micropore structures and more direct lithium-ion channels in the cathode electrode sheet during the drying process, which can reduce the tortuosity and McMullin number of the electrode sheet under the same volume density, and improve the electrical performance of a battery such as conductivity and rate performance. Meanwhile, the addition of an organic acid can effectively reduce the residual alkali content in the cathode active material and improve the processability of the slurry.

In a further embodiment, the method further comprises the step S3 of drying the cathode electrode sheet obtained in the step S2 to produce a cathode electrode sheet with micropores. Through this drying step, CO₂ and H₂O generated in the neutralization reaction can better volatilize, which is more conducive to the formation of micropore structures and direct lithium-ion channels.

Preferably, the drying temperature in the step S3, in an embodiment, can be 100-150° C. The drying temperature in the step S3 can be 100° C., 105° C., 110° C., 115° C., 120° C., 125° C., 130° C., 135° C., 140° C., 145° C., or 150° C. Within this drying temperature range, CO₂ and H₂O generated in the neutralization reaction can better volatilize, which is more conducive to the formation of micropore structures and direct lithium-ion channels.

In a further embodiment, the addition ratio of lithium carbonate is 0.05 wt % to 5 wt % of the solid component in the first slurry. Within this addition ratio range, it can not only ensure the generation of more micropore structures and more direct lithium-ion channels in the cathode electrode sheet, but also better ensure that it will not adversely affect other performance of the battery.

The addition ratio of lithium carbonate can be, in an embodiment, 0.05 wt %, 0.1 wt %, 0.15 wt %, 0.2 wt %, 0.5 wt %, 0.8 wt %, 1 wt %, 1.2 wt %, 1.5 wt %, 1.8 wt %, 2 wt %, 2.2 wt %, 2.5 wt %, 2.8 wt %, 3 wt %, 3.2 wt %, 3.5 wt %, 3.8 wt %, 4 wt %, 4.2 wt %, 4.5 wt %, 4.8 wt % or 5 wt % of the solid component in the first slurry.

In a further embodiment, the organic acid is selected from one or more of maleic acid, glycolic acid, acrylic acid, fumaric acid, malonic acid, succinic acid, malic acid, tricarballylic acid, and aconitic acid. The organic acids from the above list are easier to be obtained commercially and more cost-effective, and by using the organic acids from the above list, CO₂ and H₂O can be better generated during the neutralization reaction, resulting in the formation of more micropore structures and more direct lithium-ion channels in the cathode electrode sheet during the drying process.

In a further embodiment, the cathode active material is selected from one or more of lithium manganate, lithium cobaltate, lithium iron phosphate, lithium titanate, and lithium iron manganese phosphate. The above are just examples of the cathode active materials, which are not limited thereto. Those skilled in the art can choose appropriate cathode active materials according to actual needs.

In a further embodiment, the particle size of lithium carbonate is 50 nm to 10 μm. Within this particle size range, through the reaction between lithium carbonate and organic acid, the size of the generated micropores can be effectively controlled, thereby more effectively improving the electrical performance of the battery, such as conductivity and rate performance.

The particle size of lithium carbonate, in an embodiment, can be 50 nm, 1 micron, 1.1 microns, 1.2 microns, 1.3 microns, 1.4 microns, 1.5 microns, 1.6 microns, 1.7 microns, 1.8 microns, 1.9 microns, 2 microns, 2.1 microns, 2.2 microns, 2.3 microns, 2.4 microns, 2.5 microns, 2.6 microns, 2.7 microns, 2.8 microns, 2.9 microns, 3 microns, 3.1 microns, 3.2 microns, 3.3 microns, 3.4 microns, 3.5 microns, 3.6 microns, 3.7 microns, 3.8 microns, 3.9 microns, 4 microns, 4.1 microns, 4.2 microns, 4.3 microns, 4.4 microns, 4.5 microns, 4.6 microns, 4.7 microns, 4.8 microns, 4.9 microns, 5 microns, 5.1 microns, 5.2 microns, 5.3 microns, 5.4 microns, 5.5 microns, 5.6 microns, 5.7 microns, 5.8 microns, 5.9 microns, 6 microns, 6.1 microns, 6.2 microns, 6.3 microns, 6.4 microns, 6.5 microns, 6.6 microns, 6.7 microns, 6.8 microns, 6.9 microns, 7 microns, 7.1 microns, 7.2 microns, 7.3 microns, 7.4 microns, 7.5 microns, 7.6 microns, 7.7 microns, 7.8 microns, 7.9 microns, 8 microns, 8.1 microns, 8.2 microns, 8.3 microns, 8.4 microns, 8.5 microns, 8.6 microns, 8.7 microns, 8.8 microns, 8.9 microns, 9 microns, 9.1 microns, 9.2 microns, 9.3 microns, 9.4 microns, 9.5 microns, 9.6 microns, 9.7 microns, 9.8 microns, 9.9 microns or 10 microns.

In a further embodiment, the step S1 comprises the following steps:—step S11: mixing the cathode conductive agent, the cathode binder, and the solvent to obtain a uniform solution;—step S12: adding lithium carbonate to the uniform solution to obtain a conductive adhesive solution; and—step S13: adding the cathode active material to the conductive adhesive solution to obtain the first slurry.

In a further embodiment, the step S2 comprises the following steps:—step S21: adding an organic acid to the first slurry and mixing them to obtain a second slurry, then evenly coating the second slurry onto the aluminum foil to prepare the cathode electrode sheet; or—step S22: evenly coating the first slurry onto the aluminum foil to prepare a primary electrode sheet, then spray coating an organic acid ethanol solution onto the primary electrode sheet or soaking the primary electrode sheet in an organic acid ethanol solution to prepare the cathode electrode sheet.

In a further embodiment, the step S2 further comprises a step S23: cleaning the cathode electrode sheet with an ethanol solution after the step S22. Using ethanol to clean the cathode electrode sheet can remove the residual organic acid from the cathode electrode sheet, which can reduce the impact of residual organic acid on the electrical performance of the electrode sheet after drying.

According to yet another embodiment of the present disclosure, a lithium-ion battery is provided, comprising a cathode electrode sheet, a anode electrode sheet, and a separator, wherein the cathode electrode sheet is the cathode electrode sheet described above in the present disclosure or prepared by the method described above in the present disclosure.

In an embodiment of the present disclosure, by adding lithium carbonate to the slurry and adding an organic acid to the slurry or soaking the electrode sheet in an organic acid, CO₂ and H₂O are generated during the neutralization reaction, resulting in the formation of micropore structures and more direct lithium-ion channels in the electrode sheet during the drying process, which can reduce the tortuosity and McMullin number of the electrode sheet under the same volume density, and improve the electrical performance of a battery such as conductivity and rate performance.

Meanwhile, the addition of an organic acid can effectively reduce the residual alkali content in the cathode active material and improve the processability of the slurry.

### EXAMPLES

Examples of the present disclosure are described below in further detail according to an embodiment.

### Preparation of Cathode Electrode Sheet

### Example 1 (LFP-1)

1) 3 g of carbon black cathode conductive agent, 4 g of PVDF cathode binder, and 42 ml of N-methylpyrrolidone solvent were mixed, and placed in a planetary stirrer to form a uniform solution, and then 0.5 g of lithium carbonate (with a particle size of about 3 μm) was added to the uniform solution, the mixture was continuously stirred for 30 minutes to obtain a conductive adhesive solution
2) After the adhesive solution was mixed evenly, 92.5 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) 0.93 g of maleic acid (consistent with the molar ratio of total lithium carbonate in the slurry) was added to the first slurry, the mixture was continuously stirred for half an hour to obtain the second slurry;
4) The second slurry was evenly coated onto the aluminum foil, the surface density was controlled at about 20 mg/cm², which was then baked at 100° C. for 10 minutes to obtain the cathode electrode sheet.

### Example 2 (LFP-2)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., then soaked in 300 ml of maleic acid ethanol solution with a concentration of 1 wt %, and baked at 100° C. for 10 minutes to obtain the cathode electrode sheet.

### Example 3 (LFP-3)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., then soaked in 300 ml of maleic acid ethanol solution with a concentration of 1 wt % to obtain the cathode electrode sheet;
4) The cathode electrode sheet was dried at 100° C. before soaked in 300 ml of ethanol solution to clean the residual maleic acid solution on the cathode electrode sheet, and finally, the cathode electrode sheet was dried in an oven at 100° C.

### Example 4 (LCO-4)

1) 3 g of carbon black cathode conductive agent, 4 g of PVDF cathode binder, and 25 ml of N-methylpyrrolidone solvent were mixed, and placed in a planetary stirrer to form a uniform solution, and then 0.5 g of lithium carbonate (with a particle size of about 3 μm) was added to the uniform solution, the mixture was continuously stirred for 30 minutes to obtain a conductive adhesive solution
2) After the adhesive solution was mixed evenly, 92.5 g of lithium cobaltate cathode active material was added and mixed thoroughly, which was then diluted with 3.2 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 20 mg/cm², and the primary electrode sheet was dried in an oven at 100° C., then soaked in 300 ml of maleic acid ethanol solution with a concentration of 1 wt %, and baked at 100° C. for 10 minutes to obtain the cathode electrode sheet.

### Example 5 (LTO-5)

1) 3 g of carbon black cathode conductive agent, 4 g of PVDF cathode binder, and 42 ml of N-methylpyrrolidone solvent were mixed, and placed in a planetary stirrer to form a uniform solution, and then 1 g of lithium carbonate (with a particle size of about 3 μm) was added to the uniform solution, the mixture was continuously stirred for 30 minutes to obtain a conductive adhesive solution
2) After the adhesive solution was mixed evenly, 92 g of lithium titanate cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 20 mg/cm², and the primary electrode sheet was dried in an oven at 100° C., then soaked in 300 ml of maleic acid ethanol solution with a concentration of 1 wt %, and baked at 100° C. for 10 minutes to obtain the cathode electrode sheet.

### Example 6 (LMFP-6)

1) 3 g of carbon black cathode conductive agent, 4 g of PVDF cathode binder, and 42 ml of N-methylpyrrolidone solvent were mixed, and placed in a planetary stirrer to form a uniform solution, and then 0.2 g of lithium carbonate (with a particle size of about 3 μm) was added to the uniform solution, the mixture was continuously stirred for 30 minutes to obtain a conductive adhesive solution
2) After the adhesive solution was mixed evenly, 92.8 g of lithium iron manganese phosphate cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 20 mg/cm², and the primary electrode sheet was dried in an oven at 100° C., then soaked in 300 ml of maleic acid ethanol solution with a concentration of 1 wt %, and baked at 100° C. for 10 minutes to obtain the cathode electrode sheet.

### Example 7 (LMO-7)

1) 3 g of carbon black cathode conductive agent, 4 g of PVDF cathode binder, and 25 ml of N-methylpyrrolidone solvent were mixed, and placed in a planetary stirrer to form a uniform solution, and then 0.5 g of lithium carbonate (with a particle size of about 3 μm) was added to the uniform solution, the mixture was continuously stirred for 30 minutes to obtain a conductive adhesive solution
2) After the adhesive solution was mixed evenly, 92.5 g of lithium manganate cathode active material was added and mixed thoroughly, which was then diluted with 4 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 20 mg/cm², and the primary electrode sheet was dried in an oven at 100° C., then soaked in 300 ml of maleic acid ethanol solution with a concentration of 1 wt %, and baked at 100° C. for 10 minutes to obtain the cathode electrode sheet.

### Example 8 (LCO-8)

1) 3 g of carbon black cathode conductive agent, 4 g of PVDF cathode binder, and 25 ml of N-methylpyrrolidone solvent were mixed, and placed in a planetary stirrer to form a uniform solution, and then 0.5 g of lithium carbonate (with a particle size of about 3 μm) was added to the uniform solution, the mixture was continuously stirred for 30 minutes to obtain a conductive adhesive solution
2) After the adhesive solution was mixed evenly, 92.5 g of lithium cobaltate cathode active material was added and mixed thoroughly, which was then diluted with 3.2 ml of N-methylpyrrolidone solvent to control the viscosity ranging from 5 Pa·s to 10 Pa·s, so that the first slurry was obtained;
3) 0.785 g of maleic acid (consistent with the molar ratio of total lithium carbonate in the slurry) was added to the first slurry, the mixture was continuously stirred for half an hour to obtain the second slurry;
4) The second slurry was evenly coated onto the aluminum foil, the surface density was controlled at about 20 mg/cm², which was then baked at 100° C. for 10 minutes to obtain the cathode electrode sheet.

### Example 9 (LMFP-9)

1) 3 g of carbon black cathode conductive agent, 4 g of PVDF cathode binder, and 42 ml of N-methylpyrrolidone solvent were mixed, and placed in a planetary stirrer to form a uniform solution, and then 0.2 g of lithium carbonate (with a particle size of about 3 μm) was added to the uniform solution, the mixture was continuously stirred for 30 minutes to obtain a conductive adhesive solution
2) After the adhesive solution was mixed evenly, 92.8 g of lithium iron manganese phosphate cathode active material was added and mixed thoroughly, which was then diluted with 12 ml of N-methylpyrrolidone solvent to control the viscosity ranging from 5 Pa·s to 10 Pa·s, so that the first slurry was obtained;
3) 0.31 g of maleic acid (consistent with the molar ratio of total lithium carbonate in the slurry) was added to the slurry, the mixture was continuously stirred for half an hour to obtain the second slurry;
4) The second slurry was evenly coated onto the aluminum foil, the surface density was controlled at about 20 mg/cm², which was then baked at 100° C. for 10 minutes to obtain the cathode electrode sheet.

### Example 10 (LFP-10)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate cathode active material (containing 0.1 wt % of lithium carbonate) was added and mixed thoroughly, which was then diluted with 12 ml of N-methylpyrrolidone solvent to control the viscosity ranging from 5 Pa·s to 10 Pa·s;
3) The slurry was evenly coated onto the aluminum foil, the surface density was controlled at 22 mg/cm², and the primary electrode sheet was dried in an oven at 100° C., then soaked in 300 ml of glycolic acid ethanol solution with a concentration of 1 wt %, and baked at 100° C. for 10 minutes to obtain the cathode electrode sheet.

### Example 11 (LFP-11)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., then soaked in 300 ml of acrylic acid ethanol solution with a concentration of 1 wt %, and baked at 100° C. for 10 minutes to obtain the cathode electrode sheet.

### Example 12 (LFP-12)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., then soaked in 300 ml of fumaric acid ethanol solution with a concentration of 1 wt %, and baked at 100° C. for 10 minutes to obtain the cathode electrode sheet.

### Example 13 (LFP-13)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., then soaked in 300 ml of malonic acid ethanol solution with a concentration of 1 wt %, and baked at 100° C. for 10 minutes to obtain the cathode electrode sheet.

### Example 14 (LFP-14)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., and soaked in 300 ml of succinic acid ethanol solution with a concentration of 1 wt % at the same time, and baked at 100° C. for 10 minutes to obtain the cathode electrode sheet.

### Example 15 (LFP-15)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., then soaked in 300 ml of malic acid in ethanol solution with a concentration of 1 wt %, and baked at 100° C. for 10 minutes to obtain the cathode electrode sheet.

### Example 16 (LFP-16)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., and soaked in 300 ml of tricarballylic acid ethanol solution with a concentration of 1 wt % at the same time, and baked at 100° C. for 10 minutes to obtain the cathode electrode sheet.

### Example 17 (LFP-17)

1) 3 g of carbon black cathode conductive agent, 4 g of PVDF cathode binder, and 42 ml of N-methylpyrrolidone solvent were mixed, and placed in a planetary stirrer to form a uniform solution, and then 0.8 g of lithium carbonate (with a particle size of about 3 μm) was added to the uniform solution, the mixture was continuously stirred for 30 minutes to obtain a conductive adhesive solution
2) After the adhesive solution was mixed evenly, 92.2 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) The first slurry was evenly coated onto the aluminum foil to obtain the primary electrode sheet, the surface density was controlled at 22 mg/cm², and the primary electrode sheet was dried in an oven at 100° C., then soaked in 300 ml of aconitic acid ethanol solution with a concentration of 1 wt %, and baked at 100° C. for 10 minutes to obtain the cathode electrode sheet.

### Example 18 (LFP-18)

1) 3 g of carbon black cathode conductive agent, 4 g of PVDF cathode binder, and 42 ml of N-methylpyrrolidone solvent were mixed, and placed in a planetary stirrer to form a uniform solution, and then 0.05 g of lithium carbonate (with a particle size of about 3 μm) was added to the uniform solution, the mixture was continuously stirred for 30 minutes to obtain a conductive adhesive solution;
2) After the adhesive solution was mixed evenly, 92.95 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) 0.225 g of maleic acid was added to the first slurry, the mixture was continuously stirred for half an hour to obtain the second slurry;
4) The second slurry was evenly coated onto the aluminum foil, the surface density was controlled at about 20 mg/cm², which was then baked at 100° C. for 10 minutes to obtain the cathode electrode sheet.

### Example 19 (LFP-19)

1) 3 g of carbon black cathode conductive agent, 4 g of PVDF cathode binder, and 42 ml of N-methylpyrrolidone solvent were mixed, and placed in a planetary stirrer to form a uniform solution, and then 5 g of lithium carbonate (with a particle size of about 3 μm) was added to the uniform solution, the mixture was continuously stirred for 30 minutes to obtain a conductive adhesive solution;
2) After the adhesive solution was mixed evenly, 88 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) 7.99 g of maleic acid was added to the first slurry, the mixture was continuously stirred for half an hour to obtain the second slurry;
4) The second slurry was evenly coated onto the aluminum foil, the surface density was controlled at about 20 mg/cm², which was then baked at 100° C. for 10 minutes to obtain the cathode electrode sheet.

### Example 20 (LFP-20)

1) 3 g of carbon black cathode conductive agent, 4 g of PVDF cathode binder, and 42 ml of N-methylpyrrolidone solvent were mixed, and placed in a planetary stirrer to form a uniform solution, and then 0.5 g of lithium carbonate (with a particle size of about 50 nm) was added to the uniform solution, the mixture was continuously stirred for 30 minutes to obtain a conductive adhesive solution
2) After the adhesive solution was mixed evenly, 92.5 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) 0.93 g of maleic acid was added to the first slurry, the mixture was continuously stirred for half an hour to obtain the second slurry;
4) The second slurry was evenly coated onto the aluminum foil, the surface density was controlled at about 20 mg/cm², which was then baked at 100° C. for 10 minutes to obtain the cathode electrode sheet.

### Example 21 (LFP-21)

1) 3 g of carbon black cathode conductive agent, 4 g of PVDF cathode binder, and 42 ml of N-methylpyrrolidone solvent were mixed, and placed in a planetary stirrer to form a uniform solution, and then 0.5 g of lithium carbonate (with a particle size of about 10 μm) was added to the uniform solution, the mixture was continuously stirred for 30 minutes to obtain a conductive adhesive solution
2) After the adhesive solution was mixed evenly, 92.5 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the first slurry was obtained;
3) 0.93 g of maleic acid was added to the first slurry, the mixture was continuously stirred for half an hour to obtain the second slurry;
4) The second slurry was evenly coated onto the aluminum foil, the surface density was controlled at about 20 mg/cm², which was then baked at 100° C. for 10 minutes to obtain the cathode electrode sheet.
   Control group 1 (LFP-1s)
1) 3 g of carbon black cathode conductive agent, 4 g of PVDF cathode binder, and 42 ml of N-methylpyrrolidone solvent were mixed, and placed in a planetary stirrer to form a uniform solution;
2) After the solution was mixed evenly, 93 g of lithium iron phosphate (containing 0.1 wt % of lithium carbonate) cathode active material was added and mixed thoroughly, which was then diluted with 12 ml of N-methylpyrrolidone solvent to control the viscosity ranging from 5 Pa·s to 10 Pa·s, so that the slurry was obtained;
3) The slurry was evenly coated onto the aluminum foil, the surface density was controlled at about 20 mg/cm², which was then baked at 100° C. for 10 minutes to obtain the cathode electrode sheet.
   Control group 2 (LCO-2s)
1) 3 g of carbon black cathode conductive agent, 4 g of PVDF cathode binder, and 25 ml of N-methylpyrrolidone solvent were mixed, and placed in a planetary stirrer to form a uniform solution;
2) After the solution was mixed evenly, 93 g of lithium cobaltate cathode active material was added and mixed thoroughly, which was then diluted with 3.2 ml of N-methylpyrrolidone solvent to control the viscosity ranging from 5 Pa·s to 10 Pa·s, so that the slurry was obtained;
3) The slurry was evenly coated onto the aluminum foil, the surface density was controlled at about 20 mg/cm², which was then baked in an oven at 100° C. for 10 minutes to obtain the cathode electrode sheet.
   Control group 3 (LTO-3s)
1) 3 g of carbon black cathode conductive agent, 4 g of PVDF cathode binder, and 42 ml of N-methylpyrrolidone solvent were mixed, and placed in a planetary stirrer to form a uniform solution;
2) After the solution was mixed evenly, 93 g of lithium titanate material was added and mixed thoroughly, which was then diluted with 12 ml of N-methylpyrrolidone solvent to control the viscosity ranging from 5 Pa·s to 10 Pa·s, so that the slurry was obtained;
3) The slurry was evenly coated onto the aluminum foil, the surface density was controlled at about 20 mg/cm², which was then baked in an oven at 100° C. for 10 minutes to obtain the cathode electrode sheet.
   Control group 4 (LMFP-4s)
1) 3 g of carbon black cathode conductive agent, 4 g of PVDF cathode binder, and 42 ml of N-methylpyrrolidone solvent were mixed, and placed in a planetary stirrer to form a uniform solution;
2) After the solution was mixed evenly, 93 g of lithium iron manganese phosphate cathode active material was added and mixed thoroughly, which was then diluted with 12 ml of N-methylpyrrolidone solvent to control the viscosity ranging from 5 Pa·s to 10 Pa·s, so that the slurry was obtained;
3) The slurry was evenly coated onto the aluminum foil, the surface density was controlled at about 20 mg/cm², which was then baked in an oven at 100° C. for 10 minutes to obtain the cathode electrode sheet.
   Control group 5 (LMO-5s)
1) 3 g of carbon black cathode conductive agent, 4 g of PVDF cathode binder, and 42 ml of N-methylpyrrolidone solvent were mixed, and placed in a planetary stirrer to form a uniform solution;
2) After the solution was mixed evenly, 93 g of lithium manganate cathode active material was added and mixed thoroughly, which was then diluted with 12 ml of N-methylpyrrolidone solvent to control the viscosity ranging from 5 Pa·s to 10 Pa·s, so that the slurry was obtained;
3) The slurry was evenly coated onto the aluminum foil, the surface density was controlled at about 20 mg/cm², which was then baked in an oven at 100° C. for 10 minutes to obtain the cathode electrode sheet.

### Preparation of Electrolyte

10 g of ethylene carbonate, 30 g of dimethyl carbonate, and 10 g of lithium hexafluorophosphate were mixed to prepare the electrolyte.

### Assembling of Battery

The CR2016 button half-cell was assembled in a drying laboratory. The cathode electrode sheet obtained in the above steps was used as the cathode electrode and the lithium sheet was used as the anode electrode. The cathode electrode, the anode electrode, the separator and the battery shell of the button cell were assembled and the electrolyte was injected therein. After the cell was assembled, it was allowed to stand still for about 24 hours for aging so as to obtain the button half-cell.

### Test of Cell Performance

### 1. Determination of McMullin Number (Nm)

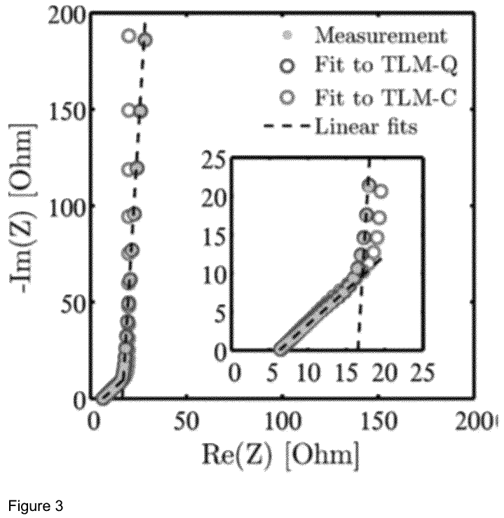

Two electrode sheets (with a diameter of 15 mm and 17 mm, respectively) were pressed and used as cathode and anode electrodes, respectively, and assembled with a glass fiber separator (with a diameter of 20 mm) to form a single-layer pouch cell, a lithium-free electrolyte (TBAClO4, Sigma Aldrich, >99.0%) was injected therein, and impedance in a range of 0.03-105 Hz was measured with an electrochemical workstation, the fitting curve in FIG. 3 was obtained according to the fitting method in Reference [Journal of The Electrochemical Society, 163 (7) A1373-A1387 (2016)], and the ionic resistance (R_{Ion}) in the electrode sheets was further calculated. The area A of the electrode sheet can be calculated based on its diameter of 15 mm, and the thickness d of the electrode sheet (excluding the current collector) can be calculated through the thickness testing. The conductivity of the electrolyte K can be calculated through the conductivity testing. By inputting the obtained data into the formula below, the Nm value of the electrode sheet can be obtained. Porosity of the electrode sheet E can be calculated by the density of each component in the electrode sheet and the volume of the electrode sheet. Tortuosity T can be calculated based on the following formula given the Nm value and E are known.

$$Nm = \frac{τ}{ε} = \frac{{R}_{lon} \cdot A \cdot κ}{d}$$

### 2. Determination of Rate Retention Rate

The rate performance of cell was determined with a charge and discharge tester. Firstly, the cell was charged at conditions of an ambient temperature of 23° C., a charge voltage of 3.7 V, and a charge current of 1 C, then it was discharged at conditions of a discharge current of 0.2C and a cut-off voltage of 2.5 V (a discharge capacity at 0.2C rate). Next, the cell was charged at conditions of an ambient temperature of 23° C., a charge voltage of 3.7 V, and a charge current of 1 C, then it was discharged at conditions of a discharge current of 10C and a cut-off voltage of 2.5 V (a discharge capacity at 10C rate). The ratio of discharge capacity at 0.2 C rate to discharge capacity at 10C rate was calculated, which was the rate retention rate (%)

$$Rate retention rate [ \% ] = ( discharge capacity at 0.2 C rate / discharge capacity at 10 C rate ) \times 100 \% .$$

### 3. Determination of Capacity Retention Rate

The discharge capacity and cycle performance of cell were determined with a charge and discharge tester.

Firstly, the cell was charged at conditions of an ambient temperature of 23° C., a charge voltage of 3.7 V, and a charge current of 0.2 C, then it was discharged at conditions of a discharge current of 0.2C and a cut-off voltage of 2.5 V, and the first discharge capacity (a discharge capacity of the 1st cycle) was measured. Next, the cell was repeatedly charged and discharged at conditions of an ambient temperature of 23° C., a charge voltage of 3.7 V, and a charge current of 1 C, and conditions of a discharge current of 2C and a cut-off voltage of 2.5 V. Subsequently, the discharge capacity of the 100th cycle was measured. Next, based on the following formula, the capacity retention rate after 100 cycles (%) was calculated based on the discharge capacity of the 1st cycle and the discharge capacity of the 100th cycle.

$$Capacity retention rate after 100 cycles [ \% ] = ( discharge capacity of 100 th cycle / discharge capacity of 1 st cycle ) \times 100 \% .$$

Table 1 shows the evaluation results of the cells prepared based on control groups 1-5 and Examples 1-21.

TABLE 1

| | | Rate retention | Capacity retention |
|---|---|---|---|
| | Nm | rate (%) | rate (%) |
| Control group 1 | 26.1 | 27.0 | 93.3 |
| (LFP-1s) | | | |
| Example 1 | 11.3 | 30.2 | 95.2 |
| (LFP-1) | | | |
| Example 2 | 15.2 | 30.0 | 99.7 |
| (LFP-2) | | | |
| Example 3 | 14.7 | 29.0 | 99.7 |
| (LFP-3) | | | |
| Example 10 | 20.1 | 31.2 | 93.5 |
| (LFP-10) | | | |
| Example 11 | 19.4 | 29.2 | 93.4 |
| (LFP-11) | | | |
| Example 12 | 18.3 | 30.3 | 94.7 |
| (LFP-12) | | | |
| Example 13 | 17.8 | 30.8 | 96.1 |
| (LFP-13) | | | |
| Example 14 | 16.8 | 30.5 | 97.5 |
| (LFP-14) | | | |
| Example 15 | 15.3 | 29.4 | 94.2 |
| (LFP-15) | | | |
| Example 16 | 14.9 | 30.2 | 95.8 |
| (LFP-16) | | | |
| Example 17 | 13.2 | 30.5 | 96.1 |
| (LFP-17) | | | |
| Example 18 | 16.8 | 29.0 | 93.9 |
| (LFP-18) | | | |
| Example 19 | 10.3 | 28.2 | 94.0 |
| (LFP-19) | | | |
| Example 20 | 13.2 | 29.8 | 94.9 |
| (LFP-20) | | | |
| Example 21 | 18.6 | 30.2 | 94.1 |
| (LFP-21) | | | |
| Control group 2 | 7.2 | 75.2 | 90.3 |
| (LCO-2s) | | | |
| Example 4 | 5.3 | 77.5 | 92.4 |
| (LCO-4) | | | |
| Example 8 | 4.8 | 77.3 | 91.8 |
| (LCO-8) | | | |
| Control group 3 | 24.6 | 83.4 | 95.7 |
| (LTO-3s) | | | |
| Example 5 | 20.8 | 86.9 | 97.6 |
| (LTO-5) | | | |
| Control group 4 | 32.5 | 30.2 | 5.0 |
| (LMFP-4s) | | | |
| Example 6 | 30.7 | 30.4 | 10.9 |
| (LMFP-6) | | | |
| Example 9 | 28.8 | 31.2 | 10.5 |
| (LMFP-9) | | | |
| Control group 5 | 8.3 | 50.1 | 58.3 |
| (LMO-5s) | | | |
| Example 7 | 7.1 | 59.4 | 64.2 |
| (LMO-7) | | | |

From the comparisons between control group 1 (LFP-1s) and Example 1 (LFP-1) to Example 21 (LFP-21) in Table 1, it can be seen that when lithium iron phosphate (LFP) is used as the cathode active material, the addition of organic acid and lithium carbonate significantly reduces the Nm of the cathode electrode sheet, improving the capacity retention rate and rate performance of the cells.

From the comparisons between control group 2 (LCO-2s) and Example 4 (LCO-4) and Example 8 (LCO-8) in Table 1, it can be seen that when lithium cobaltate (LCO) is used as the cathode active material, the addition of organic acid and lithium carbonate also significantly reduces the Nm of the cathode electrode sheet, improving the capacity retention rate and rate performance of the cells.

From the comparisons between control group 3 (LTO-3s) and Example 5 (LTO-5) in Table 1, it can be seen that when lithium titanate (LTO) is used as the cathode active material, the addition of organic acid and lithium carbonate also significantly reduces the Nm of the cathode electrode sheet, improving the capacity retention rate and rate performance of the cells.

From the comparisons between control group 4 (LMFP-4s) and Example 6 (LMFP-6) and Example 9 (LMFP-9) in Table 1, it can be seen that when lithium iron manganese phosphate (LMFP) is used as the cathode active material, the addition of organic acid and lithium carbonate also significantly reduces the Nm of the cathode electrode sheet, improving the capacity retention rate and rate performance of the cells.

Moreover, from the comparisons between control group 5 (LMO-5s) and Example 7 (LMO-7) in Table 1, it can be seen that when lithium manganate (LMO) is used as the cathode active material, the addition of organic acid and lithium carbonate also significantly reduces the Nm of the cathode electrode sheet, improving the capacity retention rate and rate performance of the cells.

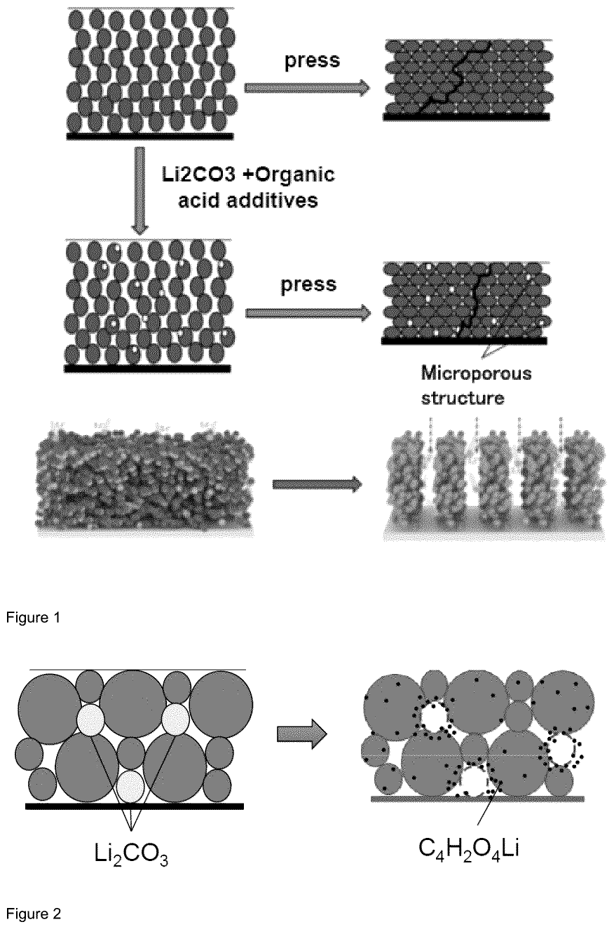

In addition, it can be seen from FIG. 1 that by adding lithium carbonate and organic acid to the slurry, CO₂ and H₂O are generated during the neutralization reaction, resulting in the formation of micropore structures and more direct lithium-ion channels in the electrode sheet during the drying process, so that the tortuosity of the electrode sheet is reduced under the same volume density.

It can be seen from the above experimental results that the above examples of the present disclosure have achieved the following technical effects:

By adding lithium carbonate to the slurry and adding an organic acid to the slurry or soaking the electrode sheet in an organic acid, CO₂ and H₂O are generated during the neutralization reaction, resulting in the formation of micropore structures and more direct lithium-ion channels in the electrode sheet during the drying process, which can reduce the tortuosity and McMullin number (Nm) of the electrode sheet under the same volume density, and improve the electrical performance of a battery such as conductivity and rate performance. Meanwhile, the addition of an organic acid can effectively reduce the residual alkali content in the cathode active material and improve the processability of the slurry.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A cathode electrode sheet, comprising: a cathode active material, a cathode conductive agent, a cathode binder, and a lithium organic acid, wherein based on a total weight of the cathode active material, the cathode conductive agent, the cathode binder, and the lithium organic acid, a content of the lithium organic acid is 0.14 wt % to 11.99 wt %.

2. The cathode electrode sheet of claim 1, wherein the cathode electrode sheet includes micropores of 1 micron to 10 microns, and the lithium organic acid is provided around the micropores.

3. The cathode electrode sheet of claim 1, wherein the lithium organic acid is provided on a surface of the cathode active material and the cathode conductive agent.

4. The cathode electrode sheet of claim 1, wherein an organic acid radical of the lithium organic acid is derived from one or more of maleic acid, glycolic acid, acrylic acid, fumaric acid, malonic acid, succinic acid, malic acid, tricarballylic acid, and aconitic acid.

5. The cathode electrode sheet of claim 1, wherein the cathode active material is selected from one or more of lithium manganate, lithium cobaltate, lithium iron phosphate, lithium titanate, and lithium iron manganese phosphate.

6. The cathode electrode sheet of claim 1, wherein the lithium organic acid is lithium maleate, and a content of the lithium maleate is 0.23 wt % to 8.83 wt %.

7. A method for preparing a cathode electrode sheet, wherein the method comprising:
mixing a cathode active material, a cathode conductive agent, a cathode binder, and lithium carbonate to obtain a first slurry; and
adding an organic acid to the first slurry and mixing to obtain a second slurry, and preparing the second slurry into a cathode electrode sheet.

8. A method of claim 7, wherein the method further comprises drying the cathode electrode sheet obtained to produce the cathode electrode sheet including micropores.

9. The method of claim 7, wherein an addition ratio of lithium carbonate is 0.05 wt % to 5 wt % of a solid component of the first slurry.

10. The method of claim 7, wherein the organic acid is selected from one or more of maleic acid, glycolic acid, acrylic acid, fumaric acid, malonic acid, succinic acid, malic acid, tricarballylic acid, and aconitic acid.

11. The method of claim 7, wherein the cathode active material is selected from one or more of lithium manganate, lithium cobaltate, lithium iron phosphate, lithium titanate, and lithium iron manganese phosphate.

12. The method of claim 7, wherein a particle size of the lithium carbonate is 50 nm to 10 μm.

13. The method of claim 7, wherein the method comprises:
mixing the cathode conductive agent, the cathode binder, and a solvent to obtain a uniform solution;
adding lithium carbonate to the uniform solution to obtain a conductive adhesive solution; and
adding the cathode active material to the conductive adhesive solution to obtain the first slurry.

14. The method of claim 7, wherein the method comprises:
adding an organic acid to the first slurry and mixing to obtain a second slurry, and evenly coating the second slurry onto an aluminum foil to prepare the cathode electrode sheet.

15. The method of claim 14, wherein the method comprises: cleaning with an ethanol solution to prepare the cathode electrode sheet.

16. A lithium-ion battery comprising:
a cathode electrode sheet,
an anode electrode sheet, and
a separator,
wherein the cathode electrode sheet is the cathode electrode sheet of claim 1.

17. A method for preparing a cathode electrode sheet, wherein the method comprising:
mixing a cathode active material, a cathode conductive agent, a cathode binder, and lithium carbonate to obtain a first slurry; and
preparing the first slurry into a primary electrode sheet, and applying an organic acid to the primary electrode sheet to produce the cathode electrode sheet.

18. The method of claim 17, wherein the method comprises: evenly coating the first slurry onto an aluminum foil to prepare the primary electrode sheet, and spray coating an organic acid ethanol solution onto the primary electrode sheet or soaking the primary electrode sheet in an organic acid ethanol solution to prepare the cathode electrode sheet.
